(19) United States
(12) Patent Application Publication
(10) Pub. No.: US 2021/0249738 A1
(43) Pub. Date: Aug. 12, 2021

(54) INTERLOCK STRUCTURE OF BATTERY PACK

(71) Applicant: HONDA MOTOR CO., LTD., Tokyo (JP)

(72) Inventors: Ryo KITANO, Saitama (JP); Masatoshi SUZUKI, Saitama (JP)

(73) Assignee: HONDA MOTOR CO., LTD., Tokyo (JP)

(21) Appl. No.: 17/168,863

(22) Filed: Feb. 5, 2021

(30) Foreign Application Priority Data
Feb. 7, 2020 (JP) 2020-020063

(51) Int. Cl. H01M 50/505; H01M 50/574; H01M 50/244; H01M 50/204; H01M 50/249

(52) U.S. Cl. CPC H01M 50/505; H01M 50/574; H01M 2220/20; H01M 50/204; H01M 50/249; H01M 50/244

(57) ABSTRACT

An interlock structure of a battery pack includes a case having a case body and a case cover, and a bus bar unit which electrically connects two battery modules. The case cover has a cover connecting portion connected to an object accommodated in the case or the case body. The bus bar unit includes, a bus bar which electrically connects the two battery modules, an insulating bus bar cover, and bolts which fix the bus bar to the two battery module. The bus bar cover includes, a bus bar cover body covering the bus bar, a removal restricting portion which is configured to restrict the cover connecting portion from being removed from the accommodated object or the case body, and an access permitting portions which are configured to allow access to the bolts.

### CROSS REFERENCE TO RELATED APPLICATIONS

This application claims priority to Japanese Patent Application No. 2020-020063 filed on Feb. 7, 2020, the content of which is incorporated herein by reference.

### TECHNICAL FIELD

The present invention relates to an interlock structure of a battery pack mounted on an electric vehicle or the like.

### BACKGROUND ART

In recent years, large-capacity battery packs have been installed in electric vehicles and the like. The battery pack contains a plurality of battery modules and high-voltage circuits in a case. The case consists of a case body and a cover and safety measures are taken so that the cover cannot be removed to access the high-voltage circuit inside the case without following a prescribed procedure. For example, JP 2014-157741 A discloses an interlock structure which includes a service plug which can switch on/off a high-voltage circuit by inserting and removing it and in which a cover and a case body cannot be disengaged when the service plug is inserted and the cover and the case body are disengaged when the service plug is removed.

According to JP 2014-157741 A, since the cover cannot be opened unless the service plug is removed and the high-voltage circuit is turned off, inadvertent access to the electrically conducting high-voltage circuit can be prevented.

However, since the interlock structure of JP 2014-157741 A uses an off-the-shelf service plug, it is necessary to design the inside of the battery pack according to the shape and dimensions of the service plug, which causes a problem that the configuration of the battery pack becomes complicated.

An aspect of the invention provides an interlock structure of a battery pack which can be realized with a simple configuration without using an off-the-shelf product such as a service plug.

### SUMMARY OF INVENTION

According to an aspect of the present invention, there is provided an interlock structure of a battery pack, wherein

the battery pack includes,
a plurality of battery modules,
a case having a case body accommodating the plurality of battery modules and a case cover covering the case body, and
a bus bar unit which electrically conducts two battery modules out of the plurality of battery modules,

the case cover has a cover connecting portion connected to an object accommodated in the case or the case body,

the bus bar unit includes,
a bus bar which electrically connects the two battery modules,
a bus bar cover with an insulation property which is not removable in an up-down direction with respect to at least the bus bar, and
bolts which fix the bus bar to the two battery module at electrical connection portions between the two battery modules and the bus bar unit, and

the bus bar cover includes,
a bus bar cover body covering the bus bar,
a removal restricting portion which is configured to restrict the cover connecting portion from being removed from the accommodated object or the case body, and
an access permitting portions which are configured to allow access to the bolts.

### BRIEF DESCRIPTION OF DRAWINGS

FIG. 1 is a plan view of a battery pack having an interlock structure according to an embodiment of the invention.

FIG. 2 is a plan view of a main part of the battery pack of FIG. 1 with a maintenance lid removed.

FIG. 3 is an enlarged perspective view of FIG. 2.

FIG. 4 is an exploded perspective view of a bus bar unit forming the interlock structure according to the embodiment of the invention.

FIG. 5 is a perspective view of a contact regulating portion of the bus bar unit of FIG. 4.

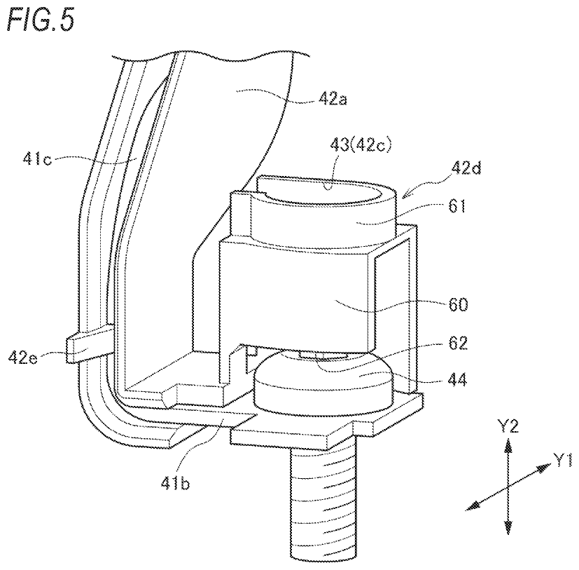

FIG. 6 is a cross-sectional view of the contact regulating portion of FIG. 5 for explaining a contact regulation function.

FIG. 7 is a cross-sectional view taken along the line A-A of FIG. 2 in which a tool is inserted into an access permitting portion.

FIG. 8 is a cross-sectional view taken along the line A-A of FIG. 2 in which a bolt is loosened by a tool from a state of FIG. 7.

### DESCRIPTION OF EMBODIMENTS

Hereinafter, an embodiment of an interlock structure of a battery pack of the invention will be described with reference to the accompanying drawings.

Battery Pack

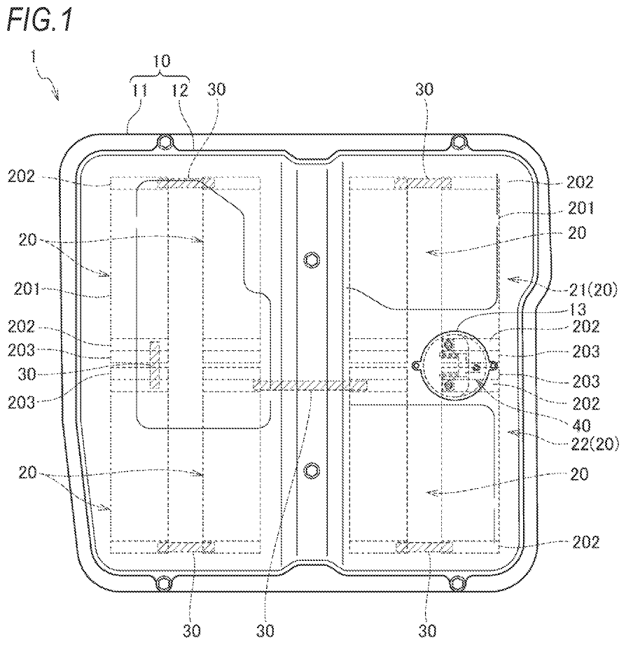

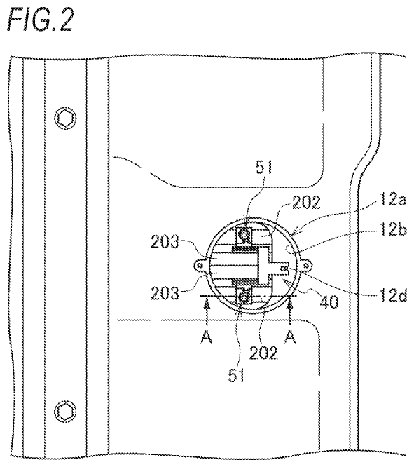

As illustrated in FIGS. 1 and 2, a battery pack 1 of the embodiment has a case 10 having a substantially rectangular shape in a plan view and a plurality of (eight in this example) battery modules 20 having a substantially rectangular shape in a plan view are accommodated in the case 10. The plurality of battery modules 20 are electrically connected in series by electrically conducting the battery modules 20 adjacent to each other via a bus bar 30. Two battery modules 20 (hereinafter, these two battery modules are referred to as battery modules 21 and 22.) out of the plurality of battery modules 20 are electrically conductive via a bus bar unit 40 having the bus bar 30 (hereinafter, this bus bar is referred to as a bus bar 41).

Each battery module 20 includes a cell laminate body 201 composed by laminating a plurality of cells, a pair of end plates 202 arranged on both sides of the cell laminate body 201 in a stacking direction, and a voltage detection device (Cell Voltage Sensor) 203 which detects the voltage of each cell of the cell laminate body 201. In the embodiment, the voltage detection device 203 of each battery module 20 is arranged between the adjacent end plates 202 of the adjacent battery modules 21 and 22 and the bus bar unit 40 described above is arranged so as to straddle the voltage detection device 203 of the battery modules 21 and 22.

The case 10 has a case body 11 which accommodates the battery module 20, the bus bar 30, and the bus bar unit 40 and a case cover 12 which covers the case body 11.

The case cover 12 is provided with a substantially circular case opening 12a on an upper surface. As illustrated in FIG. 1, the case opening 12a is closed with a maintenance lid 13. At the time of maintenance of the battery pack 1, by removing the maintenance lid 13, as illustrated in FIG. 2, an electrical connection portion 51 for electrically connecting the battery modules 21 and 22 and the bus bar unit 40 can be accessed through the case opening 12a.

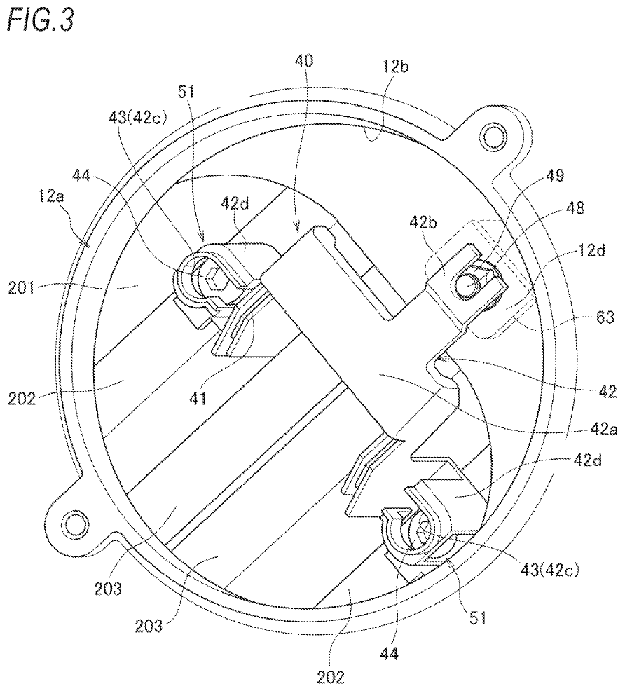

As illustrated in FIG. 3, the case cover 12 has a cover connecting portion 12d which connects an object accommodated in the case 10 or the case body 11. The cover connecting portion 12d is formed so as to extend from a part of an edge 12b of the case opening 12a toward the center of the opening. The accommodated object in the case 10 connected to the cover connecting portion 12d may be the battery modules 21 and 22, may be the end plates 202 of the battery modules 21 and 22, may be the voltage detection device 203 arranged between the end plates 202, or a support bracket 63 for supporting the voltage detection device 203. The cover connecting portion 12d of the embodiment is fixed to the support bracket 63 which supports the voltage detection device 203.

More specifically, in the cover connecting portion 12d, a cover fixing bolt 48 extending from below the support bracket 63 is exposed on the upper surface of the cover connecting portion 12d through a bolt hole provided in the cover connecting portion 12d, and by fastening a nut 49 to the cover fixing bolt 48, the support bracket 63 (the object accommodated in the case 10) and the cover connecting portion 12d are fixed, Therefore, in order to remove the case cover 12, it is necessary to first loosen the nut 49 to release the fixing between the cover connecting portion 12d and the accommodated object (support bracket 63).

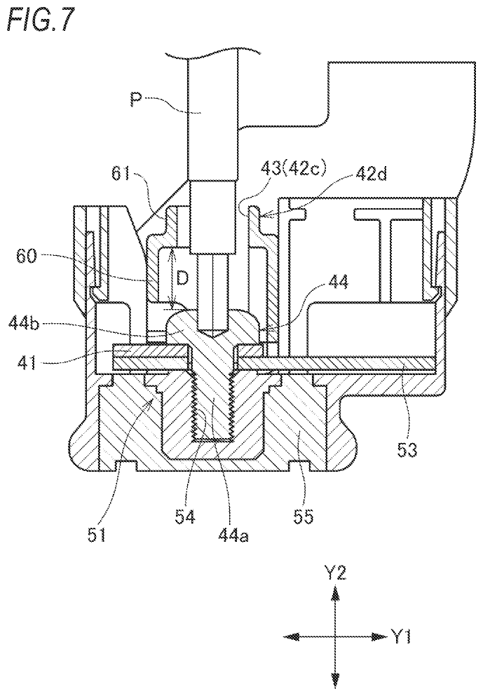

As illustrated in FIG. 7, in an electrical connection portion 51, terminal portions 53 of the battery modules 21 and 22 and the bus bar 41 of the bus bar unit 40 are fastened with a bus bar fixing bolt 44.

Bus Bar Unit

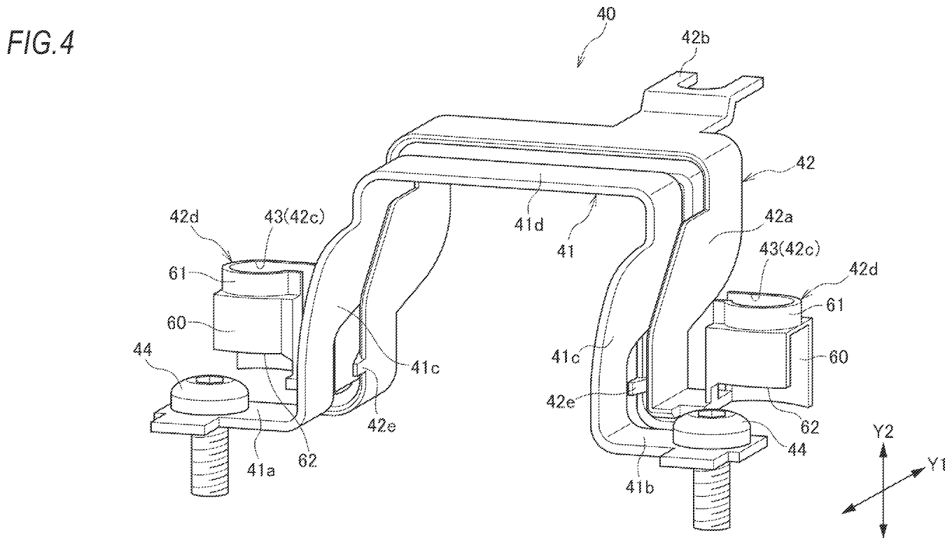

As illustrated in FIGS. 3 and 4, the bus bar unit 40 includes the bus bar 41 which electrically connects the battery modules 21 and 22, an insulating bus bar cover 42, and the bus bar fixing bolts 44 and 44 for fixing the bus bar 41 to the battery modules 21 and 22 at the electrical connection portion 51.

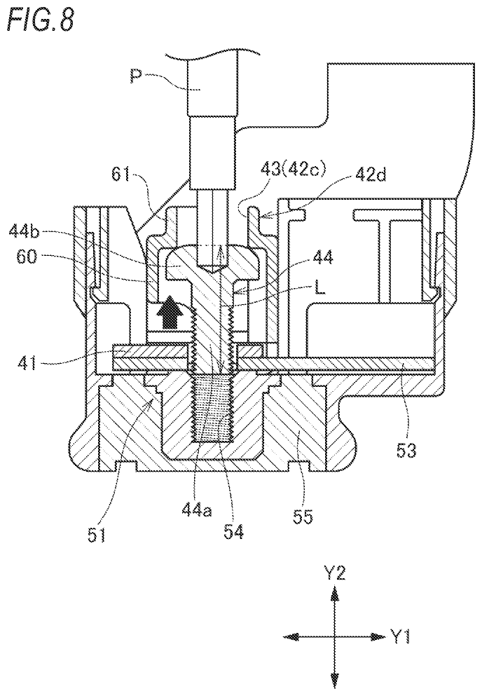

The bus bar 41 is constructed by bending a conductive plate material and includes a first fixing portion 41a provided with the bus bar fixing bolt 44 fixed to a terminal block 55 (see FIGS. 7 and 8) of the battery module 21, a second fixing portion 41b provided with the bus bar fixing bolt 44 fixed to the terminal block 55 (see FIGS. 7 and 8) of the battery module 22, a pair of pier portions 41c extending upward from the inner ends of the first fixing portion 41a and the second fixing portion 41b, and a bridge girder portion 41d which connects a pair of pier portions 41c to each other,

The bus bar cover 42 is configured to be assembled horizontally (arrow Y1 in FIG. 4) with respect to the bus bar 41 and is not removable in an up-down direction (arrow Y2 in FIG. 4). More specifically, the bus bar cover 42 is configured such that a bus bar cover body 42a having a U-shaped cross section with only one side open in a horizontal direction pinches a pair of pier portions 41c and the bridge girder portion 41d of the bus bar 41. Therefore, the bus bar 41 can be inserted and removed only from the opening side of the bus bar cover body 42a having a U-shaped cross section and cannot be removed in the up-down direction. In FIG. 4, reference numerals and letters 42e indicate an engaging portion which holds the bus bar 41 so that the bus bar 41 does not come off the bus bar cover 42 in the horizontal direction after assembly. The number of engaging portions 42e may be one or a plural. Although the bus bar 41 may be molded on the bus bar cover 42, the bus bar unit 40 can be easily manufactured by configuring the bus bar 41 so that it can be assembled from the horizontal direction as in the embodiment.

The bus bar cover 42 is further provided with a removal restricting portion 42b extending substantially horizontally from the upper surface of the bus bar cover body 42a to regulate the cover connecting portion 12d from being removed from the support bracket 63 and contact regulating portions 42d extending from the bus bar cover body 42a in opposite directions each other and covering the upper parts of the bus bar fixing bolts 44.

As illustrated in FIG. 3, the removal restricting portion 42b extends from the bus bar cover body 42a above the cover connecting portion 12d toward the cover fixing bolt 48. The removal restricting portion 42b has a substantially U-shaped claw portion when viewed from above and the claw portion is configured to cover the nut 49 fastened to the cover fixing bolt 48. Therefore, it is necessary to remove the bus bar unit 40 to loosen the nut 49. Further, in order to remove the bus bar unit 40, it is necessary to remove the bus bar fixing bolt 44 to release the connection (contact) between the terminal portion 53 in the electrical connection portion 51 and the bus bar 41 in the bus bar unit 40. As a result, the case cover 12 is restricted from being removed in a state where the bus bar unit 40 is not removed, that is, in a state where the battery modules 21 and 22 are electrically conductive.

The contact regulating portion 42d has a tubular body formed so as to surround the bus bar fixing bolt 44. As described above, since the bus bar cover 42 includes the contact regulating portion 42d extending from the bus bar cover body 42a and covering the upper part of the bus bar fixing bolt 44, contacting with the bus bar fixing bolt 44 or the bus bar 41 is prevented in a state where the battery modules 21 and 22 are electrically conductive.

The contact regulating portion 42d is provided with an access permitting portion 42c on the upper surface thereof to allow access to the bus bar fixing bolt 44. The access permitting portion 42c is an opening 43 which penetrates the contact regulating portion 42d in the up-down direction. Therefore, the bus bar fixing bolt 44 can be accessed from above via the access permitting portion 42c. At the time of maintenance, an operator can insert a tool P and remove the bus bar fixing bolt 44 from the access permitting portion 42c (opening 43) provided in the contact regulating portion 42d, as illustrated in FIG. 7. By removing the bus bar fixing bolt 44, the electrical continuity of the battery modules 21 and 22 is released and the bus bar unit 40 can be further removed from the battery modules 21 and 22.

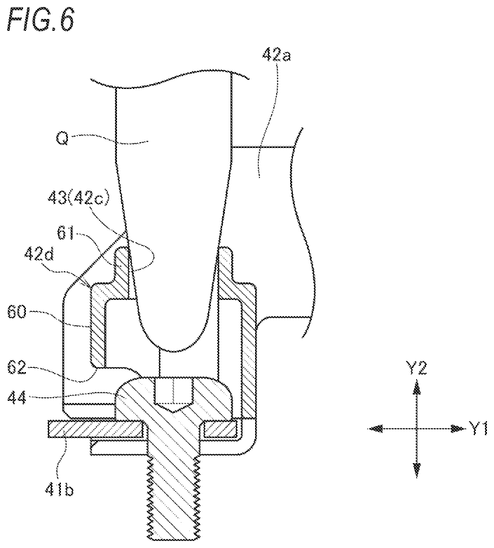

Here, the contact regulating portion 42d includes a tubular portion 60 having a diameter larger than that of a bolt head 44b of the bus bar fixing bolt 44 and surrounding the circumference of the bus bar fixing bolt 44 and a reduced diameter portion 61 which is continuously provided above the tubular portion 60 and has a diameter smaller than that of the tubular portion 60 and the opening 43 is provided so as to penetrate the reduced diameter portion 61 in the up-down direction. Further, the bus bar fixing bolt 44 is a hexagon socket head cap screw in which a hexagon socket hole is provided on the upper surface of the bolt head 44b. In this way, by making the bus bar fixing bolt 44 a hexagon socket head cap screw, the opening 43 can be made smaller than the bolt head 44b when viewed from above. In other words, since the tool P for removing the bus bar fixing bolt 44 can be smaller than the bolt head 44b, the opening 43 can be made smaller accordingly. As a result, as illustrated in FIG. 6, even when an operator's finger Q accidentally invades through the opening 43, it is possible to more appropriately prevent the finger Q from coming into contact with the bus bar fixing bolt 44 or the bus bar 41. In addition, below the tubular portion 60, on one side in the horizontal direction (arrow Y1 in FIG. 4), a notch portion 62 is formed so that the bus bar cover 42 can be assembled in the horizontal direction (arrow Y1 in FIG. 4) with respect to the bus bar 41 to which the bus bar fixing bolt 44 is attached.

As described above, the tubular portion 60 has a larger diameter than the bolt head 44b. Further, a distance D (see FIG. 7) between the lower surface of the opening 43 and the bolt head 44b, which is the length of the tubular portion 60, is shorter than a length L (see FIG. 8) of the bus bar fixing bolt 44. Needless to say, the distance D between the lower surface of the opening 43 and the bolt head 44b needs to be longer than the length at which the bus bar fixing bolt 44 deviates from the terminal portion 53 of the battery modules 21 and 22, As a result, as illustrated in FIGS. 7 and 8, even when the tool P is inserted through the opening 43 to loosen the bus bar fixing bolt 44, the bus bar fixing bolt 44 can be retained inside the tubular portion 60, and thus it is possible to prevent the bus bar fixing bolt 44 from falling out. Also, as described above, since the bus bar cover 42 cannot be removed from the bus bar 41, the bus bar 41, the bus bar cover 42, and the bus bar fixing bolt 44 can be handled integrally when the bus bar cover 42 is removed. Thus, the maintenance workability is excellent.

Procedure for Removing Case Cover

Next, a procedure for removing the case cover 12 will be described.

First, the maintenance lid 13 is removed from the case cover 12 in a state where the case opening 12a is closed by the maintenance lid 13.

Next, the bus bar fixing bolts 44 fixed to the terminal blocks 55 of the battery modules 21 and 22 are removed from the terminal blocks 55 of the battery modules 21 and 22.

As illustrated in FIG. 7, the operation of removing the bus bar fixing bolts 44 from the terminal blocks 55 of the battery modules 21 and 22 is performed as follows. A hexagon wrench as the insulating tool P is inserted from the opening 43 provided in the contact regulating portion 42d of the bus bar cover 42 and the tool P is fit to the bolt head 44b of the bus bar fixing bolt 44, and then the bus bar fixing bolt 44 is rotated in a loosening direction. As a result, a shaft portion 44a of the bus bar fixing bolt 44 is pulled out from a screw hole 54 of the terminal block 55 and the connection between the bus bar 41 of the bus bar unit 40 and the terminal portions 53 of the battery modules 21 and 22 is released. In this case, the bus bar fixing bolt 44 is held inside the tubular portion 60.

After disconnecting the bus bar unit 40 and the battery modules 21 and 22 as described above, the bus bar unit 40 is pinched through the case opening 12a and the bus bar unit 40 is removed from the battery modules 21 and 22.

At this point, the electrical connection between the battery modules 21 and 22 is released and the removal restricting portion 42b of the bus bar cover 42 which covers the nut 49 is also removed, so that the nut 49 can be accessed. An operator loosens the nut 49 to release the fixing of the cover connecting portion 12d with the support bracket 63. As a result, the case cover 12 can be removed from the case body 11.

Then, by removing the case cover 12 from the case body 11, maintenance work in the bus bar unit 40 can be performed.

As described above, according to the embodiment, the case cover 12 can be removed from the case body 11 only after the bus bar unit 40 is removed from the battery modules 21 and 22 and the electrical connection between the battery modules 21 and 22 is released. Therefore, the interlock structure of the battery pack 1 can be realized with a simple configuration without using an off-the-shelf product such as a service plug.

The above-described embodiment can be appropriately modified, improved, and the like.

For example, in the embodiment described above, although the case where the cover connecting portion 12d is connected to the case body 11 via the accommodated object of the case 10 is illustrated, the cover connecting portion 12d may be connected to the case body 11 without using the accommodated object of the case 10.

At least the following matters are described in this specification. The components and the like corresponding to that of the above-described embodiment are shown in parentheses, but the invention is not limited thereto.

(1) An interlock structure of a battery pack (battery pack 1), where

the battery pack includes,
a plurality of battery modules (battery modules 20),
a case (case 10) having a case body (case body 11) accommodating the plurality of battery modules and a case cover (case cover 12) covering the case body, and
a bus bar unit (bus bar unit 40) which electrically conducts two battery modules (battery modules 21 and 22) out of the plurality of battery modules,

the case cover has a cover connecting portion (cover connecting portion 12d) connected to an object (support bracket 63) accommodated in the case or the case body,

the bus bar unit includes,
a bus bar (bus bar 41) which electrically connects the two battery modules,
a bus bar cover (bus bar cover 42) with an insulation property which is not removable in an up-down direction with respect to at least the bus bar, and
bolts (bus bar fixing bolt 44) which fix the bus bar to the battery module at an electrical connection portions (electrical connection portion 51) between the two battery modules and the bus bar unit, and

the bus bar cover includes,
a bus bar cover body (bus bar cover body 42a) covering the bus bar,
a removal restricting portion (removal restricting portion 42b) which is configured to restrict the cover connecting portion from being removed from the accommodated object or the case body, and
an access permitting portions (access permitting portion 42c) which are configured to allow access to the bolts.

According to (1), since the bus bar unit includes the removal restricting portion which restricts the cover connecting portion from being removed from the accommodated object or the case body, it is regulated that the case cover is removed when the bus bar unit is not removed, that is, when the tow battery modules are electrically conductive. Therefore, it is possible to realize the interlock structure of the battery pack with a simple configuration without using an off-the-shelf product such as a service plug.

(2) The interlock structure of the battery pack according to (1), where

the bus bar cover further includes contact regulating portions (contact regulating portion 42d) extending from the bus bar cover body and covering above the respective bolts,

the access permitting portions are openings (opening 43) provided in the respective contact regulating portions, and

each of the openings is smaller than a bolt head (bolt head 44b) of each of the bolts when viewed from above.

According to (2), since the bus bar cover further includes the contact regulating portion extending from the bus bar cover body and covering above of the bolt, the contact with the bolt and the bus bar is prevented in a state where the two battery modules are electrically conductive.

Further, the access permitting portion is the opening provided in the contact regulating portion, and since the opening is smaller than the bolt head of the bolt when viewed from above, the contact with the bolt or the bus bar can be avoided more appropriately.

(3) The interlock structure of the battery pack according to (2), where

each of the contact regulating portions has a tubular body, and

a distance (distance D) between a lower surface of each of the openings and the bolt head is shorter than a length (length L) of each of the bolts.

According to (3), since the distance between the lower surface of the opening and the bolt head is shorter than the length of the bolt, even when the tool P is inserted through the opening and the bolt is loosened, the bolt can be retained inside the tubular body and the bolt can be prevented from falling off.

(4) The interlock structure of the battery pack according to any one of (1) to (3), where

the bus bar cover is configured so that it can be assembled horizontally with respect to the bus bar.

According to (4), since the bus bar cover can be assembled horizontally with respect to the bus bar, the bus bar unit can be easily manufactured.

(5) The interlock structure of the battery pack according to (4), where

the bus bar cover is provided with an engaging portion (engaging portion 42e) for preventing the bus bar from coming off horizontally from the bus bar cover after assembly.

According to (5), since the bus bar cover is provided with the engaging portion for preventing the bus bar from coming off horizontally from the bus bar cover after assembly, even when the bus bar cover is configured so that it can be assembled horizontally with respect to the bus bar, it is possible to prevent the bus bar from coming off the bus bar cover during maintenance work.

What is claimed is:

1. An interlock structure of a battery pack, wherein
the battery pack includes,
a plurality of battery modules,
a case having a case body accommodating the plurality of battery modules and a case cover covering the case body, and
a bus bar unit which electrically conducts two battery modules out of the plurality of battery modules,
the case cover has a cover connecting portion connected to an object accommodated in the case or the case body,
the bus bar unit includes,
a bus bar which electrically connects the two battery modules,
a bus bar cover with an insulation property which is not removable in an up-down direction with respect to at least the bus bar, and
bolts which fix the bus bar to the two battery module at electrical connection portions between the two battery modules and the bus bar unit, and
the bus bar cover includes,
a bus bar cover body covering the bus bar,
a removal restricting portion which is configured to restrict the cover connecting portion from being removed from the accommodated object or the case body, and
an access permitting portions which are configured to allow access to the bolts.

2. The interlock structure of the battery pack according to claim 1, wherein
the bus bar cover further includes contact regulating portions extending from the bus bar cover body and covering above the respective bolts,
the access permitting portions are openings provided in the respective contact regulating portions, and
each of the openings is smaller than a bolt head of each of the bolts when viewed from above.

3. The interlock structure of the battery pack according to claim 2, wherein
each of the contact regulating portions has a tubular body, and
a distance between a lower surface of each of the openings and the bolt head is shorter than a length of each of the bolts.

4. The interlock structure of the battery pack according to claim 1, wherein
the bus bar cover is configured so that it can be assembled horizontally with respect to the bus bar.

5. The interlock structure of the battery pack according to claim 4, wherein
the bus bar cover is provided with an engaging portion for preventing the bus bar from coming off horizontally from the bus bar cover after assembly.
